(19) United States
(12) Patent Application Publication
(10) Pub. No.: US 2024/0019918 A1
(43) Pub. Date: Jan. 18, 2024

(54) CONDITIONAL ADJUSTMENTS TO POWER DELIVERY EFFICIENCY

(71) Applicant: Intel Corporation, Santa Clara, CA (US)

(72) Inventors: Ravi Verma, Bangalore (IN); Saunak Bhalsod, Ahmedabad (IN); Venkataramani Gopalakrishnan, Folsom, CA (US); Archana Rao, Bangalore (IN); Raghavendra Rao, Bangalore (IN); Tomer Savariego, Lavon (IL); Chuen Ming Tan, Bayan Lepas (MY); Manjunatha V, Karnataka (IN)

(21) Appl. No.: 18/472,833

(22) Filed: Sep. 22, 2023

(51) Int. Cl. G06F 1/26

(52) U.S. Cl. CPC G06F 1/26

(57) ABSTRACT

A power delivery architecture is described that improves system voltage conversion and operational efficiency. The power delivery architecture performs monitoring of various system conditions such as a current power state, a current power policy setting, workload conditions, component temperatures, a state of charge of a battery, etc. The power delivery architecture may adjust the power profile provided by a power delivery source, which may result in an adjustment to the VBUS voltage and/or current when a USB-based power delivery architecture is implemented. The power delivery architecture may also adjust a mode of operation of an onboard battery charger.

### BACKGROUND

Electronic devices are increasingly implementing a power delivery architecture utilizing universal serial bus (USB) ports. These USB ports may use type-C connectors, which have been expanded to support higher power profiles. Such USB ports are typically coupled to a corresponding USB power delivery (PD) source, such as an AC-to-DC adapter or dock. The PD source provides power to the electronic device in accordance with one of several power profiles that represent a combination of a USB bus voltage (VBUS) and current. The VBUS voltage is provided as an input voltage to a DC-to-DC voltage converter, the output of which is coupled to a battery charger. Thus, the PD source sources power and the downstream voltage regulators, such as the DC-to-DC voltage converter and battery charger, act as power sinks. The USB specification provides for a negotiating scheme in which a host device may communicate with the PD source to negotiate a contract for a specific power profile, i.e. a specific combination of VBUS voltage and current. However, once an explicit power profile contract is established between the source and sink, the VBUS voltage remains at a constant level regardless of operational power demand or other system conditions.

This conventional approach is less efficient because the efficiency power factor of the battery charger is extremely low at high input voltages (i.e. when VBUS is much higher than the battery voltage) and lower output current. Additionally, the PD source will experience continuous power loss regardless of the power state of the electronic device, i.e. even if the system is in idle/standby state or any other lower power state. This power loss reduces system efficiency and may affect the overall system power.

### BRIEF DESCRIPTION OF THE DRAWINGS/FIGURES

The accompanying drawings, which are incorporated herein and form a part of the specification, illustrate the present disclosure and, together with the description, further serve to explain the principles and to enable a person skilled in the pertinent art to make and use the techniques discussed herein.

In the drawings, like reference characters generally refer to the same parts throughout the different views. The drawings are not necessarily to scale, emphasis instead generally being placed upon illustrating the principles of the disclosure. In the following description, reference is made to the following drawings, in which:

FIG. 1 illustrates a power delivery architecture, in accordance with the disclosure;

FIGS. 2A-2C illustrate a flow diagram for managing power delivery (PD) power profiles and

battery charging modes based upon the current power policy setting, in accordance with the disclosure;

FIGS. 3A-3B illustrate a flow diagram for managing power delivery (PD) power profiles and battery charging modes once a power delivery contract is established, in accordance with the disclosure; and

FIG. 4 illustrates screenshots showing various power policy settings, in accordance with the disclosure.

The present disclosure will be described with reference to the accompanying drawings. The drawing in which an element first appears is typically indicated by the leftmost digit(s) in the corresponding reference number.

### DETAILED DESCRIPTION

The following detailed description refers to the accompanying drawings that show, by way of illustration, exemplary details in which the disclosure may be practiced. In the following description, numerous specific details are set forth in order to provide a thorough understanding of the present disclosure. However, it will be apparent to those skilled in the art that the various designs, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

### I. USB Specification Overview

The Universal Serial Bus (USB) industry standard specifies both the physical interfaces and protocols for connecting, data transferring, and powering of hosts, such as personal computers, peripherals, mobile devices, intermediate hubs, etc. In July 2012, the USB Promoters Group announced the finalization of the USB Power Delivery (USB-PD) specification (USB PD rev. 1), an extension that specifies using certified PD aware USB cables with standard USB Type-A and Type-B connectors to deliver increased power (more than 7.5 W) to devices with greater power demands. Thus, USB-PD A and B plugs have a mechanical mark while Micro plugs have a resistor or capacitor attached to the ID pin indicating the cable capability. Support for USB Type-C was finalized in August 2014 as part of the USB Type-C Specification 1.0. The USB Power Delivery specification revision 2.0 (USB PD Rev. 2.0) was released as part of the USB 3.1 suite, and provides power profiles having a VBUS voltage of 5, 9, 15, and 20 V, with a maximum of 5 A for a maximum power delivery of 100 W. As part of this specification, the standard power range (SPR) power profiles were defined, i.e. USB-PD devices can request higher currents and supply voltages from compliant hosts—up to 2 A at 5 V (for a power consumption of up to 10 W), and optionally up to 3 A or 5 A at either 12 V (36 W or 60 W) or 20 V (60 W or 100 W). In all cases, both host-to-device and device-to-host configurations are supported.

In May 2021, the USB PD promoter group launched revision 3.1 of the specification. Revision 3.1 adds the Extended Power Range (EPR) mode, which allows higher voltages of 28, 36, and 48 V, providing up to 240 W of power (48 V at 5 A), and the “Adjustable Voltage Supply” (AVS) protocol that allows specifying the voltage from a range of 15 to 48 V in 100 mV steps. Thus, the most recent USD PD source power rules at the time of this writing include the USB PD rev. 2.0/3.1 source power rules, although the most recent USD specification is the USB4 revision 2.0 released in September of 2022.

### II. Power Delivery and Power Profile Overview

The USB Power Delivery specification provided in accordance with the USB PD rev. 2.0/3.1 source power rules also defines a power negotiation scheme. This scheme enables a host device to request or “negotiate” an explicit “contract” between itself and a USB PD source in accordance with the capabilities of the PD source and the needs of the host. The contract may define a specific power profile, i.e. a combination of a VBUS voltage and current to be provided to the host, to facilitate maximum power delivery.

However, once such a contract has been established via the PD source and the host, conventional power delivery architectures do not adjust the negotiated power profile based upon various system conditions such as a current power state, the current workload, the time of day, the current power profile, operating temperature, etc. Instead, conventional power delivery architectures maintain the same voltage and current settings, i.e. the same power profile, despite any changes in such system conditions, which results in poor power efficiency. For instance, conventional USB PD sources maintain the VBUS voltage at a fixed level regardless of system conditions, and AC-DC conversion is always on once a PD power profile has been negotiated. This approach is less efficient at lower power or idle states or for certain workloads. Moreover, when system power consumption is less, DC-DC conversion for the battery charger becomes more lossy primarily due to switching losses at the higher negotiated VBUS voltage. Additionally, in conventional power delivery architectures, when the USB PD source remains plugged into the electronic device and the system is in a low power state such as powered off, a sleep state, etc., sustained higher power is drawn due to AC-DC conversion, which is less efficient.

Furthermore, programmable power supplies (PPS) may be implemented in USB PD sources, although such implementations have been limited to only charging the battery and power profile adjustments are not based upon dynamic changes of various system conditions. That is, PPS features for USB PD sources are limited to adjusting the power profiles with respect to charging batteries with more granularity by changing the voltage and current in steps instead of changing the power profile in response to other system conditions as described herein. Moreover, PPS adapters are costly and require specific HW/FW implementation, thereby significantly increasing the cost of the AC adapter and that of the system in which it is implemented. In contrast, the power delivery architecture as discussed in further detail herein may be extended to existing standard power range (SPR) and extended power range (EPR) USB adapters without the need for specialized adapters. As a result, the features as discussed herein may be facilitated within the existing ecosystem of USB power delivery sources.

### III. A Power Delivery Architecture

The power delivery architectures as discussed in further detail herein addresses these issues and improves system conversion and operational efficiency by sending control data to the PD source, which results in the PD source changing the output voltage and/or current (i.e. the power profile) depending upon various system conditions. Such system conditions, which may impact adjustments to the power profile, may include a current power state such as an active use state, various non-active use states (such as various degrees of sleep states), or a powered down (i.e. off) state. Adjustments to the power profile may include not only adjustments to the VBUS voltage, but also adjustments to an operating state of the power delivery source itself. This may include causing the power delivery source to shutdown (or restore) AC-to-DC conversion depending on system conditions.

The system conditions may also include workload conditions such as the number and/or type of applications that is/are currently running on the operating system, and may additionally or alternatively include a state of charge (i.e. a charging level) of a battery, a temperature of one or more components of the host device, power policy settings, etc. Thus, the power delivery architecture as discussed herein may lower the surface temperature of various system components during different modes of operation to provide higher thermal headroom for Turbo operations. The system conditions may additionally or alternatively include a current time in which the electronic device is being used, which may be within or outside of a predetermined range of hours such as established working hours. Additional details regarding the use and type of system conditions that may result in changes to the power profile, as well as other operational changes in the host device such as battery charging, are discussed in greater detail below.

The power delivery architecture as discussed herein may thus facilitate an improvement in efficiency that effectively reduces the carbon footprint of the system in which the power delivery architecture is implemented. Specifically, the power delivery architecture as discussed herein may improve operational efficiency of modern mobile platforms in different non-active use states, such as various sleep states, while using a PD source such as a USB Type-C PD adapter.

In this regard, it is noted that although the power delivery architectures are discussed in further detail herein in terms of the most current version of the USB Power Delivery specification at the time of this writing, the power delivery architectures are not limited to a specific protocol, standard, or connectors, although the power delivery profiles as discussed herein may comply with any of the USB power rules (i.e. power profiles). Moreover, the power delivery architectures as discussed herein are not limited to the current USB standards, and may be implemented in accordance with newer USB standards and/or revisions that are released after this writing.

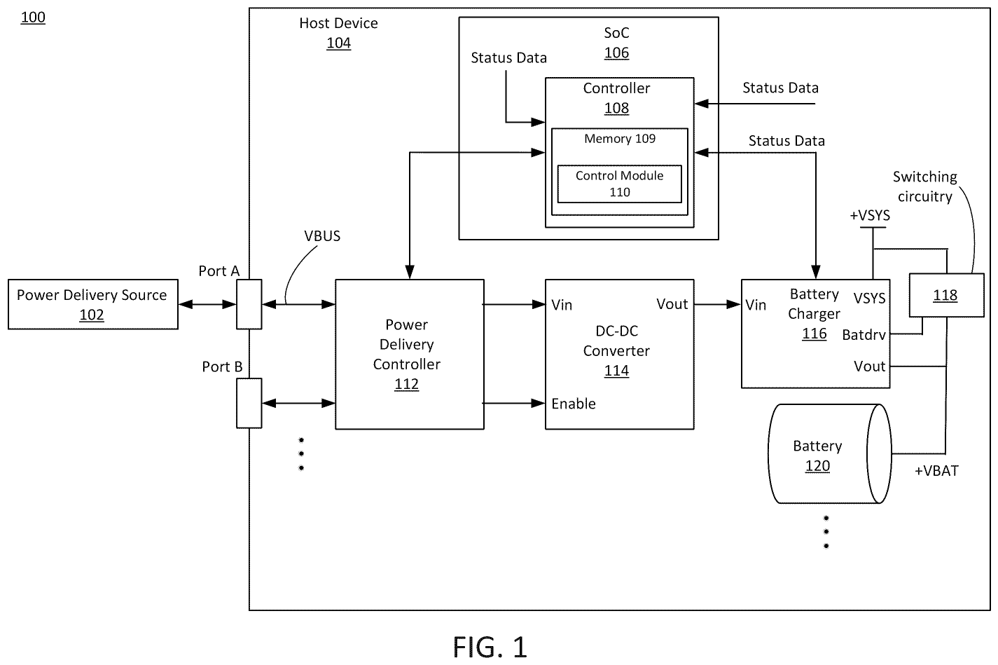

FIG. 1 illustrates a power delivery architecture, in accordance with the disclosure. The power delivery architecture 100 as shown in FIG. 1 comprises a power delivery (PD) source 102 coupled to a host device 104. The PD source 102 may be implemented as any suitable type of device that is configured to provide power to the host device 104, as further discussed herein. In various non-limiting and illustrative scenarios, the PD source 102 may comprise a USB power adapter, a dock (such as a thunderbolt dock), etc. the PD source 102 comprises an AC-DC converter and is coupled to one or more ports of the host device 104 (such as via port A as shown) via a USB compatible cable. The PD source 102 is configured to be coupled to any of the ports of the host device 104, with port A being used as shown in FIG. 1, via any suitable type of cable, bus, wired connections, etc., to provide power to the host device 104. The PD source 102 may be configured to deliver power to the host device 104 via the coupled port in accordance with any suitable number of power profiles, which may comprise a combination of a VBUS voltage and a current that complies with a universal serial bus (USB) power delivery profile specification as noted herein. The PD source 102 may also communicate with one of more components of the host device 104 via this coupled connection, which may comprise communications in accordance with a USB communication protocol or any other suitable protocol or standard. Additional capabilities of the PD source 102 are further discussed in detail below.

The host device 104 may be implemented as any suitable type of electronic device that receives power from the PD source 102. In various non-limiting and illustrative scenarios, the host device 104 may comprise a laptop computer, a tablet computer, a personal computer, a mobile device, a wearable electronic device, etc. The host device 104 may implement any suitable number of ports, with two (i.e. ports A and B) being shown in FIG. 1 as a non-limiting and illustrative scenario. Again, the power may be delivered by the PD source 102 to one or more ports of the host device 104 in accordance with a power profile that represents a combination of a VBUS voltage and a current that complies with a universal serial bus (USB) power delivery profile specification. The VBUS voltage and current provided in this manner may be utilized by one or more components of the host device 104 to provide system power, battery charging, etc. as discussed in further detail below.

The host device 104 comprises a system 106, which may be coupled to and/or configured to communicate with one or more components of the host device 104. The system 106 may be implemented as any suitable type of hardware circuitry, may such as one or more chiplets, a system on a chip (SoC), etc., as software, or combinations of these, and may be implemented as any suitable number of processors, processing circuitry, hardware components, central processing units (CPUs), graphic processing units (GPUs), etc. In a non-limiting and illustrative scenario, the system 106 may comprise part of a system board that is implemented by the host device 104. The system 106 may control and/or monitor the operation and functions of one or more components of the host device during its use. Thus, the system 106 may comprise any suitable number of data interfaces, with some shown in FIG. 1 represented by the various arrows connected to the controller 108. These data interfaces are configured to facilitate the controller 108 and/or the system 106 receiving status data via one or more components of the host device 104, as further discussed herein.

The system 106 may comprise a controller 108, which may be configured as any suitable type of hardware circuitry, software, or combinations of these, and may be implemented as an embedded controller or any other suitable type of controller configured to perform the various functions as discussed in further detail herein. The controller 108 may comprise processing circuitry which may be configured as any suitable number and/or type of computer processors, which may function to control one or more other components of the host device 104 as further discussed herein. The controller 108 may be identified with one or more processors (or suitable portions thereof) implemented by the host device 104 and/or the system 106. The controller 108 may be identified with one or more processors such as a host processor, a digital signal processor, one or more microprocessors, microcontrollers, an application-specific integrated circuit (ASIC), part (or the entirety of) a field-programmable gate array (FPGA), etc.

In any event, the controller 108 may be configured to carry out instructions to perform arithmetical, logical, and/or input/output (I/O) operations, and/or to control the operation of one or more components of the host device 104 to perform the various functions as described herein. The controller 108 may include one or more microprocessor cores, memory registers, buffers, clocks, etc., and may generate electronic instructions and/or control signals that are transmitted to one or more components of the host device 104 to control and/or modify the operation of these components. The controller 108 may additionally process status data that is received from one or more other components of the host device 104, as further discussed herein, to identify various system conditions, whether the power profile provided by the PD source 102 should be modified based upon these detected system conditions, as well as the new power profile settings and/or other operational changes to be made to the host device 104 in accordance with such modifications.

The controller 108 and/or the system 106 may comprise a memory 109, which may be implemented as any suitable type of memory that is configured to store data and/or instructions such that, when executed by the controller 108, cause the controller 108 (and thus the host device 104) to perform various functions such as controlling, monitoring, and/or regulating the operation of one or more components of the host device 104, providing data to be transmitted from one or more components of the host device 104, receiving status data and/or any other suitable data from one or more components of the host device 104, processing status data received via one or more components of the host device 104, etc., as discussed herein. The memory 109 may be implemented as any suitable type of volatile and/or non-volatile memory, including read-only memory (ROM), random access memory (RAM), flash memory, a magnetic storage media, an optical disc, erasable programmable read only memory (EPROM), programmable read only memory (PROM), etc. The memory 109 may be non-removable, removable, or a combination of both. The memory 109 may be implemented as a non-transitory computer readable medium storing one or more executable instructions such as, for example, logic, algorithms, code, etc. The instructions, logic, code, etc., stored in the memory 109 are represented by the control module 110 as shown, which may enable the functionality of the controller 108, the system 106, and/or the host device 104 to be functionally realized, as described herein.

The host device 104 further comprises a power delivery (PD) controller 112. The PD controller 112 may be configured as any suitable type of hardware circuitry, software, or combinations of these, and may be implemented as any suitable type of controller configured to perform the various functions as discussed in further detail herein. The PD controller 112 may comprise processing circuitry that may be configured as any suitable number and/or type of computer processors. The PD controller 112 may be identified with one or more processors such as a host processor, a digital signal processor, one or more microprocessors, microcontrollers, an application-specific integrated circuit (ASIC), part (or the entirety of) a field-programmable gate array (FPGA), etc. The PD controller 112 is configured to communicate with the PD source 102 in accordance with any suitable communication protocol, scheme, or standard. Such communications may be facilitated via the coupled port A and connection between the PD controller 112, the coupled port, and the PD source 102 via a wired connection as shown in FIG. 1, and may utilize a USB communication protocol that is defined in accordance with any USB-based communication specification as noted herein. To do so, the PD controller 112 may also be coupled to the controller 108 via any suitable number of communication links, which may comprise wires, buses, ports, data interfaces, etc., as denoted in FIG. 1 via the double-sided arrow coupled between the controller 108 and the PD controller 112.

In various non-limiting and illustrative scenarios, the PD controller 112 may receive data from the PD source 102 that may be used to identify the capabilities of the PD source 102 in terms of a maximum VBUS voltage and current the PD source 102 is able to supply. This may include a serial number, a unique manufacturers code, a range of operating parameters, etc. The PD controller 112 may transmit this information to the controller 108 via the communication links as noted above. The controller 108 may then determine the maximum VBUS voltage and/or current capabilities of the PD source 102 using this information in any suitable manner, such as accessing a memory, lookup table, etc. stored in a memory of the host device 104. The controller 108 may use this information, in addition to the received status data as noted herein, to determine if, when, and how the power profile of the PD source 102 should be adjusted.

As will be discussed in further detail below, the controller 108 is configured to determine a power state of the electronic device and/or other various system conditions based upon the received status data, and to transmit power delivery (PD) instructions to the PD controller 112 based upon these determined system conditions. The controller 108 is also configured to determine whether the system conditions meet one or more predetermined conditions for modifying the power profile and, if so, to transmit PD instructions to the PD controller 112 that identify a new power profile to be adopted by the PD source 102. Thus, the PD controller 112 is configured to transmit PD control data to the PD source 102 based upon these received PD instructions, which causes the PD source 102 to adjust a PD power profile that is used to provide power to the host device 104.

The host device 104 also comprises a DC-DC converter 114, which is coupled to the PD controller 112 and to a battery charger 116 via any suitable number and/or type of connections, buses, wires, ports, data interfaces, etc. The data interfaces and interconnections for the DC-DC converter 114, as well as the other components of the host device 104 as shown in FIG. 1, are represented in FIG. 1 as the various arrows connected between the respective components. The DC-DC converter 114 may be configured as any suitable type of hardware circuitry, software, or combinations of these, and may be configured to receive the VBUS voltage provided by the PD controller 112, which again is sourced by the PD source 102 as part of the power profile. Thus, the DC-DC converter is configured to receive the VBUS voltage, which may vary in accordance with any suitable range of voltage values. In a non-limiting and illustrative scenario, the VBUS voltage may vary between +5 and +48 volts in accordance with the USB power delivery specification as noted herein.

The DC-DC converter 114 is configured to condition, step up, or step down the VBUS voltage, which is then output as Vout and supplied to the battery charger 116, as further discussed herein. The DC-DC converter 114 may be configured to step down the VBUS voltage only when the VBUS voltage exceeds a predetermined voltage value, which may comprise VBUS voltage values of +28V, +36V, +48V, etc., and which are used in accordance with the higher power delivery requirements of the extended power range (EPR) power ratings supplied by the PD source 102 in accordance with the USB power delivery specification as noted herein. When the VBUS voltage is less than the predetermined voltage value (such as +5 V, +9 V, +15 V, +20 V, etc.), then the DC-DC converter may step up or pass the VBUS voltage through to the battery chargers 116 unchanged. In this way, the DC-DC converter is configured to supply the battery charger 116 with a voltage that is close to a preferred or optimum voltage used by the battery charger 116 to charge the battery 120 and/or to supply the VBUS voltage as the system voltage Vsys in a pass-through mode, as further discussed herein.

Operation of the DC-DC converter 114 may be controlled via a logic state of the enable line as shown in FIG. 1. The assertion of the enable line, which controls the activation of the DC-Dc converter 114, may be controlled in any suitable manner, including known techniques. In a non-limiting and illustrative scenario, the DC-DC converter 114 may be disabled by controlling a logic state of the enable line using any suitable type of power good logic, which may be identified with a sink FET output (not shown). The power good logic may be implemented as part of the logic of the PD controller 112, as other suitable components of the host device 104, or as separate discrete logic that may be implemented by the host device 104 (not shown). The power good logic may be used to generate the enable signal via monitoring/sensing of a sink FET output voltage and a reference voltage that is set by the VBUS voltage. Thus, the power good logic may facilitate enabling/disabling the DC-DC converter 114.

The power good logic also ensures that the DC-DC converter 114 turns on as part of a predetermined sequence. To provide an illustrative and non-limiting scenario, the VBUS voltage may first be provided at the connector port A. Next, the PD controller 112 sets the reference for the power good signal generation depending on the VBUS voltage. The PD controller 112 then switches on the sink path, and the sink FET output voltage may be monitored by the PD controller 112. Once FET output voltage (which is the input to the DC-DC converter 114) is stabilized and is greater than the power good signal, then the power good signal is asserted, resulting in the DC-DC- converter 114 in turn being asserted and the DC-DC converter 114 being activated.

The battery charger 116 may be configured as any suitable type of hardware circuitry, software, or combinations of these to facilitate the use of the output voltage provided by the DC-DC converter 114 to charge the battery or, in other instances, to provide the output voltage provided by the DC-DC converter 114 as a system bus (Vsys) voltage in a pass-through mode (PTM). The battery charger 116 may have any suitable configuration of hardware that includes a pass-through mode and performs battery charging of the battery 120 using different modes of operation, which may be controlled via the controller 108. To this end, it is noted that although a single battery 120 is shown in FIG. 1, the battery 120 may represent any suitable number of batteries, such as a battery bank or other aggregation of cells, which are charged via the battery charger 116.

The battery charger 116 may also be coupled to the controller 108 via any suitable number of communication links, which may comprise wires, buses, ports, data interfaces, etc., as denoted in FIG. 1 via the double-sided arrow coupled between the controller 108 and the PD controller 112. The battery charger 116 may be coupled to switching circuitry 118 that facilitates the switching the Vsys bus to the battery 120 or to the output of the DC-DC converter 114 in PTM, as discussed herein. This switching may be controlled bn the battery charger 116 in response to battery charger control data received from the controller 108 or, alternatively, directly via the controller 108 (connections not shown).

The battery charger 116 may be implemented as any suitable type of device to perform the functions as described herein, including known designs and configurations. In a non-limiting and illustrative scenario, the battery charger 116 may be implemented as a buck-boost charger that includes any suitable number of switching elements, such as field-effect transistors (FETs) and other suitable hardware components known to be associated with buck-boost charging configurations.

To this end, it is noted that for a given load, output voltage, and switching frequency, a buck-boost charger architecture offers better efficiency for input voltages that are closer to the output voltage. In other words, the battery charger 116 is more efficient when charging a battery using an input voltage that is closer to the battery voltage. Table 1 below provides efficiency values for a typical buck-boost architecture with a 2-cell battery configuration. In the Table 1 below, it is assumed that the battery voltage level is close to the 9 V input voltage. Thus, it is noted that Table 1 provides values for a specific implementation, and these values are expected to change depending on the implementation of the power delivery architecture 100 and/or the host device 104. Thus, the values may change for the same configuration of the power delivery architecture 100 but using different components for the DC-DC converter 114, the battery charger 116, etc.

TABLE 1
2S Battery Config., IOUT = 5 A, FSW = 800 kHz

| Vin (V) | Efficiency (%) |
|---|---|
| 9 | >97% |
| 15 | 96% |
| 20 | 95% |

Thus, the power delivery architecture 100 as described herein may increase the operating efficiency of the battery charger 116 by adjusting the power profile provided by the PD source 102 such that the VBUS voltage (or a stepped down voltage based upon the VBUS voltage) is provided as the input voltage to the battery charger 120. As the VBUS voltage may be dynamically changed based upon various system conditions as noted in further detail herein, this ensures that the battery charger 116 continuously operates at a high efficiency as the system conditions change by dynamically adjusting the power profile provided by the PD source 102.

Moreover, it is noted that at light loads a pass through mode (PTM) of a buck-boost charger architecture may be utilized to further improve system efficiency. In the PTM, the VBUS voltage is directly passed from the DC-DC converter 114 output though the FETs of the battery charger 116 (not shown) to supply to the system bus voltage Vsys, which eliminates the switching losses from conversion. Thus, the power delivery architecture 100 as discussed in further detail herein facilitates the dynamic adjustment of the VBUS voltage to optimize the conversion efficiency of the battery charger 116. The selective use of the PTM in this manner results in ˜53.8% power savings when PTM is used versus the battery charger 116 using a 48 V input with the idle display on, and ˜30.2% power saving when PTM used versus using a 48 V input during a Microsoft Teams conference call. Again, the power savings described in this context is for ease of explanation and us used to provide a comparison with one particular implementation and configuration of the power delivery architecture 100 and the host device 104. These values may change depending on the design and implementation of various circuits in the power delivery chain.

Additionally or alternatively, and as discussed in further detail below, the VBUS voltage may be changed based upon other system conditions, such as when different types of applications are running. In various non-limiting and illustrative scenarios, such applications may comprise a video streaming application, a video conferencing application, etc., being currently used or being used in excess of a predetermined threshold time period. While running such applications, the variation in platform power is less, and thus an optimum VBUS voltage may be selected to improve the efficiency of the battery charger 116.

The power delivery architecture 100 may thus use the received status data, which may be indicative of one or more system conditions as noted in further detail herein, to perform various adjustments to how power is delivered to the host device 104 and/or how the batteries of the host device 104 are charged using the delivered power. In one instance, the power delivery architecture 100 may facilitate the dynamic change in the negotiated power profile provided by the PD source 102 depending on a determined system power state, resulting in the VBUS voltage being adjusted. In other instances, the change of the power profile provided by the PD source 102 may comprise switching the AC-DC functions of the PD source 102 off, which may be in response to a current workload classification and/or determined system power state. In still other instances, the controller 108 may use the status data to determine a temperature of one or more components of the host device 104 to provide better thermal control by re-negotiating the power profile provided by the PD source 102 to a lower, more suitable power profile.

Thus, the status data may represent information that is received via any suitable number of components of the host device 104, which is processed by the controller 108 and/or the system 106 to determine how to adjust the power profile provided by the PD source 102 and/or how to adjust the operation of the battery charger 116. The status data may therefore comprise any suitable metrics and/or data that is used to determine any suitable type of relevant information that is utilized by the system 106 and/or the controller 108 to perform these actions, as discussed in further detail herein.

In various non-limiting and illustrative scenarios, the status data may represent a system power state, or a state of charge of the battery 120 such as a battery charging level and/or whether the battery is currently charging. The status data may additionally or alternatively comprise temperature data that indicates the temperature of one or more components of the host device 104. The status data may additionally or alternatively be obtained via software components, reported by, and/or derived from the execution of applications on the host 104, such as the status of executed applications, the number and/or type of applications, a processing workload, details regarding the execution of applications such as the type of video streaming, a time in which an application has been running, the current time of day, etc. The status data may additionally or alternatively comprise information regarding the current power policy settings of the host device 104. The status data may additionally or alternatively comprise power information of system rail (such as Vsys), which may be provided as a result of an operating system (OS) energy meter interface using on board power accumulator ICs, which may thus further aid in the determination of an optimal VBUS voltage as discussed in further detail herein. The status data may thus be used by the system 106 and/or the controller 108 to determine if and how the power profile should be adjusted.

### IV. Operational Flows

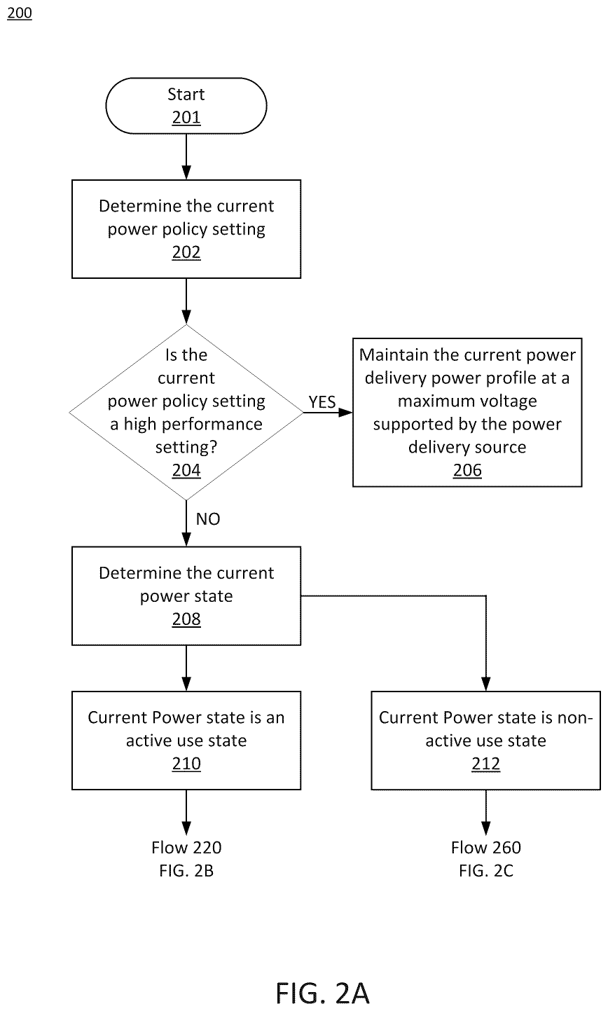

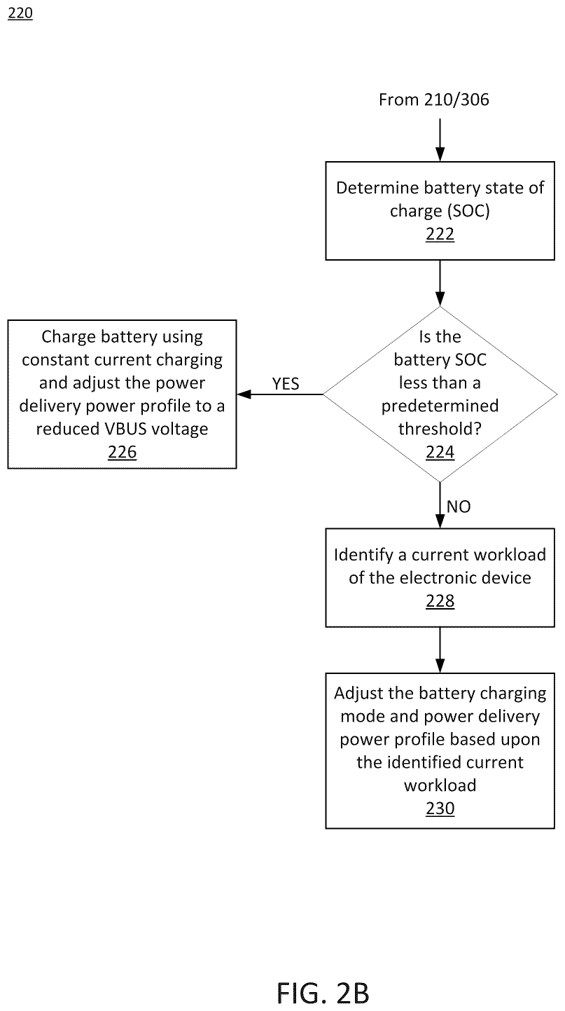

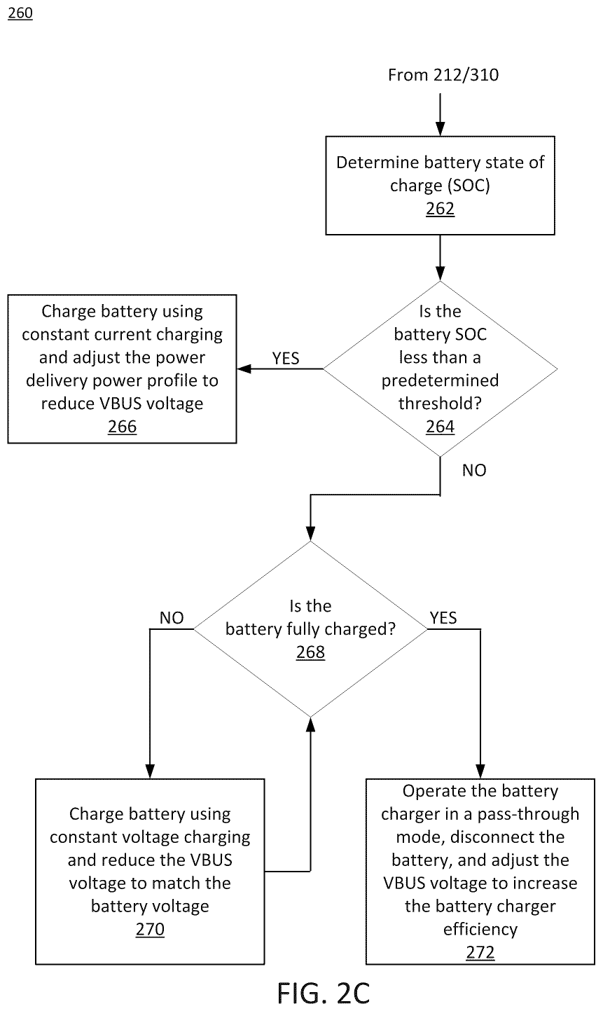

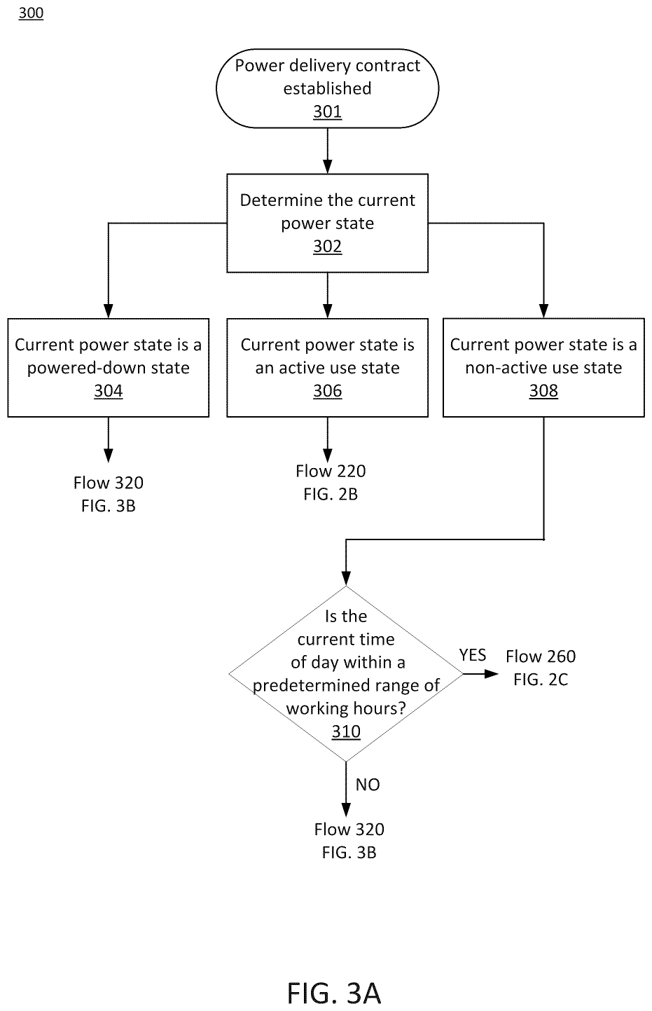

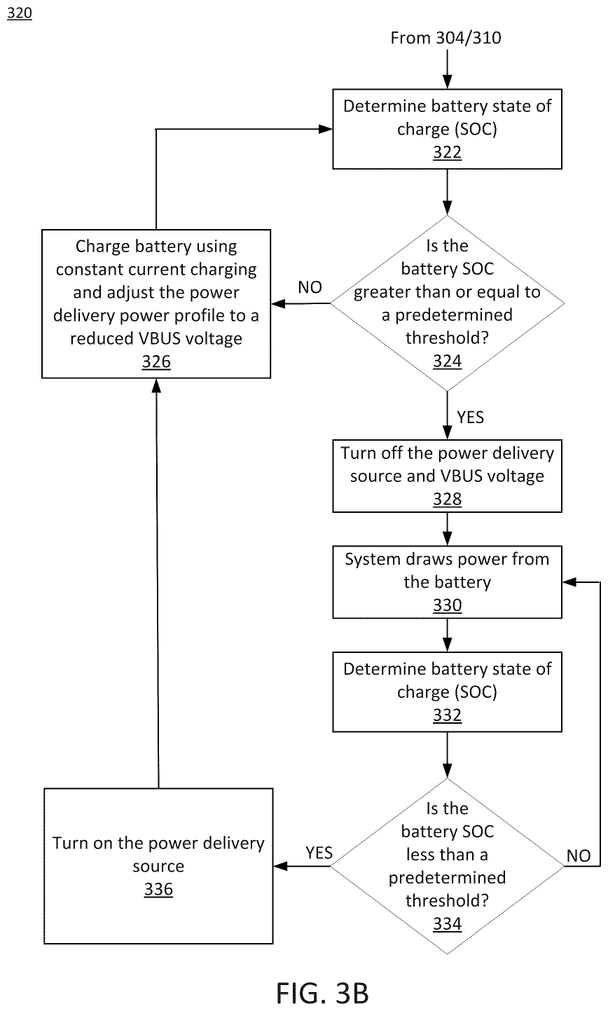

The operation of the power delivery architecture 100 is now described in further detail with respect to the flows provided in FIGS. 2A-2C and 3A-3B. Although the flows are discussed with respect to the various operations being performed by the controller 108, this is a non-limiting and illustrative scenario, and the various functions described with respect to the flows in FIGS. 2A-2C and 3A-3B may be performed by the controller 108, the system 106, or any other suitable components of the host device 104.

Turning first to FIGS. 2A-2C, the flows 200, 220, 260 illustrate flow diagrams for managing PD power profiles and battery charging modes based upon the current power policy settings, in accordance with the disclosure. In other words, for the non-limiting and illustrative scenarios represented by the flows of FIGS. 2A-2C, the current power policy setting is treated as a priority condition for determining whether to change the power profile.

Thus, and as shown in FIG. 2A, the flow 200 begins at the start block 201. At block 201, it is assumed that by default the system of the host device 104 has already negotiated for maximum power delivery, i.e. a power profile of 48V/5 A (240 W) for EPR or 20V/5 A (100 W) for SPR, via an explicit contract in accordance with the USB standard specification as noted above. The PD source 102 may, however, support lower power profiles such as 36V/5 A, 28V/5 A, 20V/5 A, etc. It is noted that the power delivery architecture 100 as described herein may facilitate efficient battery charging for any suitable range of power profiles, and may be implemented using existing SPR adapters by extending the concept within the USB-PD SPR voltage range.

In any event, in block 202 the controller 108 determines the current power policy setting. This determination may be performed via the controller 108 functioning as a device policy manager as part of the system 106, and thus the controller 108 may have access to the current power policy setting, the system power state, the battery charge status, etc. via the received status data. Moreover, the controller 108 may be one of the participants in power sequencing, and thus have access to the platform power states via the status data. It is also noted that the controller 108, acting as a policy manager for the host device 104, has access to all possible power profiles supported by the PD source 102.

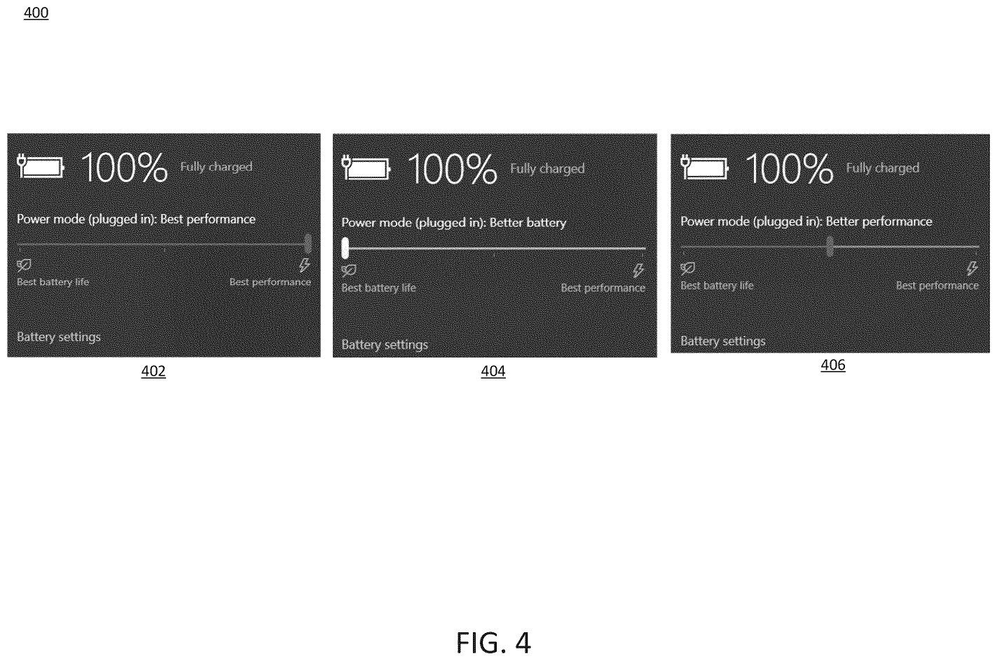

The power policy settings in this context may comprise any suitable power policy that is implemented by the host device 104, and may be the result of a user-based selection or a default selection that is established in the operating system of the host device 104. Thus, the host device 104 is configured to operate in accordance with one of several different power policy settings. In a non-limiting and illustrative scenario, the power policy settings may comprise Energy Performance Preference (EPP) settings implemented by the host device 104. FIG. 4 illustrates several screenshots of the different options for the power policy settings for the Windows operating system. The power policy settings may thus represent a high performance mode as shown in screenshot 402, an optimum battery performance mode as shown in screenshot 404, or a balance between these modes as shown in screenshot 406. Although Windows' EPP settings are shown, this is illustrative and not limiting, and the power policy settings may represent any preference or prioritization that the host device 104 may establish balancing performance and battery life.

Once the controller 108 determines (block 202) the current power policy setting, the flow 200 comprises the controller 108 determining (block 204) whether the current power policy setting comprises a high performance setting, such as the one represented in FIG. 4 via the screenshot 402. Again, for the high performance setting, the power profile provided by the PD source 102 comprises a maximum voltage that is supported by the PD source 102, which is the same as that negotiated in the start block 201. If so, then the controller 108 maintains (block 206) the current power delivery profile such that the PD source 102 continues to provide a power profile with the maximum voltage that is supported by the PD source 102. In this scenario, the controller 108 may take no further action to adjust the power profile.

However, if the controller 108 determines (block 204) that the current power policy setting is one other than the high performance setting, then the flow 200 comprises the controller 108 determining (block 208) the current power state of the host device 104. The power state in this context may comprise one of any suitable number of power states of the host device 104. In various non-limiting and illustrative scenarios, the power state may comprise a powered-down or off state, or an active use state in which the host device 104 is “fully” powered on. The host device 104 may implement additional power states, referred to herein as non-active use states, which may represent varying degrees of “sleep” between the powered-down state and the active use state. These varying degrees of sleep may correspond to one or more components of the system 106 and/or the host device 104 being shut down or placed into a standby mode of operation. To provide some non-limiting and illustrative scenarios, the display may be turned off, placed into a standby mode of operation, be decreased in brightness, etc. after a period of inactivity. As further scenarios, one or more processors or other hardware components such as disk drives may be shut down of placed into a standby mode of operation. The non-active use states may comprise an idle state or one of several degrees of sleep states, and the host 104 may progress into “deeper” sleep states as additional components are powered down and/or placed into standby mode over increasing periods of inactivity.

As shown in FIG. 2A, the flow 200 proceeds differently based upon whether the current power state is an active-use state (block 210 and flow 220) or one of several non-active use states (block 212 and flow 260). Thus, if a user prefers the “Better Battery” or “Better Performance” power policy settings, then the controller 108 may negotiate for a lower power profile to optimize the battery charger efficiency while evaluating additional system conditions. For the current scenario, these system conditions comprise the power state of the host device 104, and the preferences that drive this decision are summarized in Table 2 below.

TABLE 2

| OS power policy | Power Profile Preference |
|---|---|
| Best Performance | Keep Highest Possible Profile 48 V/5 A |
| Better Battery | Determine a new lower power profile to |
| Better Performance | optimize the battery charger efficiency |

In this way, the flow 200 as shown in FIG. 2A illustrates that the decision for renegotiation of the VBUS by the controller 108 to a lower voltage range may be determined with the power policy setting of the host device 104 given the highest priority of the system conditions. Again, to adjust the power profile, the controller 108 may renegotiate the power profile provided by the PD source 102 by transmitting PD instructions to the PD controller 112, which in turn transmits PD control data to the to the PD source 102. The PD control data, in turn causes the PD source 102 to adjust the power profile (such as by lowering the VBUS voltage) in accordance with the PD control data. Thus, and with continued reference to FIG. 2A, the controller 108 may be configured to only determine (block 208) the power state of the host device 104 and to only transmit the PD instructions to the PD controller 112 in response to the determined (block 208) power state when the host device 104 is operating in accordance with one of power policy settings other than the high performance setting.

Turning now to the flow 220 as shown in FIG. 2B, this flow represents the additional decisions performed via the controller 108 when the host device 104 is in the active state and is operating in accordance with one of power policy settings other than the high performance setting. In this scenario, the controller 108 determines (block 222) a state of charge of the battery 120. This may comprise determining a current charge level of the battery 120 via communications with the battery charger 116, which may be received as status data from the battery charger 116 as shown in FIG. 1.

The process flow 200 further comprises a determination (block 224) via the controller 108 regarding whether the current battery charging level is less than a predetermined threshold value. The predetermined threshold value may be any suitable value that indicates that the battery 120 is mostly charged, such as 80%, 90%, 95%, etc.

If the battery charge level is less than the predetermined threshold, the process flow 220 includes the controller 108 adjusting (block 226) the power profile and the battery charging mode implemented by the battery charger 116. Thus, the controller 108 transmits the PD instructions to the PD controller 112, which in turn transmits the PD control data to the PD source 102. The PD instructions in this scenario cause the PD source 102 to adjust the power profile by reducing the VBUS voltage from the maximum current setting to a reduced VBUS voltage, which may be a VBUS voltage that is passed on to the battery charger 116 via the output of the DC-DC converter 114. The VBUS voltage may be selected in this scenario such that the Vin voltage provided to the battery charger 116 is close to the current voltage level of the battery 120, thereby increasing the efficiency of the battery charger 116. Furthermore, the controller 108 may transmit battery charger control data to the battery charger 116 to cause the battery charger 116 to implement constant current charging, as this mode of charging is more efficient when batteries are not close to being fully charged.

However, when the battery charge level is greater than the predetermined threshold charging level, the process flow 220 includes the controller 108 identifying (block 228) a current workload of the host device 104. The workload of the host device 104 is thus considered a system condition as discussed herein. The determination of the workload may be identified by the controller 108 using the received status data in any suitable manner, which may include the use of specific applications and/or a predetermined level of processing power being exceeded for a predetermined threshold time. The workload may be measured via the controller 108 in this manner via a measurement of platform power used by the host device 104, with five different workload conditions being shown in Table 3 and Table 4 below for illustrative purposes.

TABLE 3

| | | | Battery Charger | | | |
|---|---|---|---|---|---|---|
| | | | Conversion Efficiency | | | |
| | | Platform | Input | | Input | Reduction |
| | Workload/Test | Power | Voltage | | Power | in Power |
| Use | Condition | (mW) | (Vin) | Efficiency | (mW) | Consumption |
| 1 | Idle display on | 1719 | 20 V | ~82% | 2096 | Max 53.8% |
| | | | 28 V | ~61% | 2818 | Min 15.8% |
| | | | 48 V | ~45% | 3820 | |
| | | | PTM | 97.5% | 1763 | |
| 2 | Video playback - | 2614 | 20 V | ~82% | 3188 | Max 53.8% |
| | H.265 - 2160p24 - | | 28 V | ~61% | 4285 | Min 15.9% |
| | 10 bits | | 48 V | ~45% | 5808 | |
| | | | PTM | 97.5% | 2681 | |
| 3 | Custom Browsing | 3376 | 20 V | ~82% | 4067 | Max 53.8% |
| | (ICOB v2) | | 28 V | ~61% | 5534 | Min 14.8% |
| | | | 48 V | ~45% | 7502 | |
| | | | PTM | 97.5% | 3462 | |
| 4 | Netflix Video | 3288 | 20 V | ~82% | 3961 | Max 53.8% |
| | Streaming 1080p | | 28 V | ~61% | 5390 | Min 14.86% |
| | | | 48 V | ~45% | 7306 | |
| | | | PTM | 97.5% | 3372 | |
| 5 | Teams 1:1 | 8246 | 20 V | ~90% | 9062 | Max 30.2% |
| | | | | | | Min 7.1% |

TABLE 4

| | | | Battery Charger Conversion | | | |
|---|---|---|---|---|---|---|
| | | | Efficiency With 0.5C Charging | | | |
| | | Platform | Input | | | Reduction |
| | Workload/Test | Power | Voltage | | Input | in Power |
| Use | Condition | (W) | (V) | Efficiency | Power(W) | Consumption |
| 1 | Idle display on | 52.848 | 20 V | ~97% | 54.48 | 6.17% |
| | | | 48 V | ~91% | 58.07 | |
| 2 | Video playback - | 53.743 | 20 V | ~97% | 55.35 | 6.26% |
| | H.265 - 2160p24 - | | 48 V | ~91% | 59.05 | |
| | 10 bits | | | | | |
| 3 | Custom Browsing | 54.505 | 20 V | ~97% | 55.96 | 6.56% |
| | (ICOB v2) | | 48 V | ~91% | 59.89 | |
| 4 | Netflix Video | 54.417 | 20 V | ~97% | 55.87 | 6.55% |
| | Streaming 1080p | | 48 V | ~91% | 59.79 | |
| 5 | Teams 1:1 | 59.375 | 20 V | ~97.2% | 61.09 | 5.86% |

The workload scenarios as shown in Tables 3 and 4 correspond to different manufactured host devices 104, each implementing the power delivery architecture 100 as discussed herein. Table 4 provides additional detail with respect to the host device 104 implementing 0.5 C charging. The workload scenarios as shown in Tables 3 and 4 above are provided in an illustrative and non-limiting manner, and the power delivery architecture 100 as discussed herein may utilize additional, alternate, or fewer workload scenarios as shown as system conditions upon which to make the decision to adjust the power profile and/or the battery charging operation. Thus, the identification (block 228) of the current workload condition may comprise, in some scenarios, the controller 108 determining if the drawn platform power is within a predetermined range for a predetermined duration of time. Additionally or alternatively, the identification (block 228) of the current workload condition may comprise the controller 108 identifying a specific application being executed for a predetermined period of time.

In any event, the controller 108 may adjust (block 230) the power profile via the transmission of PD instructions to the PD controller 112 as discussed above. Additionally, the controller 108 may adjust (block 230) the battery charging mode by lowering the VBUS voltage as a result of the adjustment to the power profile such that the input voltage to the battery charger 116 is closer to the battery voltage, as discussed herein. Thus, when the host device 104 is in an active state and the battery charge level is greater than a predetermined threshold value, the controller 108 may cause the PD source 102 to reduce the VBUS voltage based upon the identified workload to support sudden power demanded by the system 106.

To demonstrate the effectiveness of the power delivery architecture 100, it is noted that Table 3 illustrates typical mobile platform power consumption data and a reduction in power consumption for various workload scenarios. Tables 3 and 4 demonstrate the increase in efficiency of the battery charger 116 as a result of the adjustment of the power profile provided by the PD source 102. For instance, and with reference to Table 3, if a Netflix streaming application is running, then it makes sense to lower the VBUS voltage from 48V to 20V to achieve a 37% higher efficiency.

Thus, Tables 3 and 4 represent information that may be measured or otherwise obtained with respect to the host device 104 and/or the components thereof, such as the DC-DC converter 114, the battery charger 116, the battery 120, etc. For Table 3, it is noted that for the 20V and PTM operation, a sample datasheet for the battery charger 116 is used, and for the 28V and 48V VBUS voltages, the efficiency number includes the conversion efficiency of a Buck-Boost DC-DC converter and battery charger architecture. Moreover, the data in Table 4 corresponds to a three-cell battery pack (1 C=8970 mA) being charged with 0.5 C at nominal voltage of 11.4 V. The controller 108 may be programmed with, access, and/or otherwise utilize such readily attainable information, which may be specific to the manufacturer of the components and/or the architecture of the host device 104. The controller 108 may use this information to determine the adjusted (block 230) power profile settings and/or battery charger settings based upon the current workload.

To provide an illustrative and non-limiting scenario, the host device 104 may store data indicative of the optimum efficiency for various components such as the PD source 102, the DC-DC converter 114, the battery charger 116, etc. This information may be stored in any suitable location, such as a memory identified with the system 106 and/or the controller 108, or in any other suitable components of and/or accessible to the host device 104 and/or the controller 108. This efficiency information may be derived from testing and/or be known from available data provided by the manufacturers of these components. Such information may correlate the efficiency of these components with power profile settings such as the VBUS and current values.

The controller 108 may access the stored efficiency information in response to changing system conditions such as different power states, workload scenarios, etc., and use this information to determine the updated power profiles and/or battery charger modes of operation. In this way, the controller 108 may generate the PD instructions that identify, to the PD controller 112, the corresponding VBUS and current values to be requested from the PD source 102. The controller 108 may likewise use the stored efficiency information to generate the battery charger control data that instructs the battery charger 116 regarding a current charging mode and/or other suitable state of operation, as noted herein.

Turning now to the flow 260 as shown in FIG. 2C, this flow represents the additional decisions performed via the controller 108 when the host device 104 is in a non-active use state and is operating in accordance with one of power policy settings other than the high performance setting. For this scenario, the initial blocks 262, 264, and 266 are identical to the blocks 222, 224, and 226, respectively, of the flow 220 as shown in FIG. 2B. Thus, to provide an illustrative and non-limiting scenario, when the host device 104 is in an idle state or other non-active use state and the battery state of charge is less than 90%, the battery 120 is charged with a constant current of 1 C i.e., 8.96 A. In such a case, the controller 108, which again may function as a device policy manager, has access to this information and renegotiates the power profile provided by the PD source 102 to lower levels, such as a 28V/5 A power profile, which helps to reduce switching losses and improve battery charger conversion efficiency.

However, because the flow 260 corresponds to a non-active use state, the controller 108 need not determine a current workload of the host device 104. Instead, if the battery state of charge is greater than a predetermined threshold value, then the flow 260 includes the controller 108 determining (block 268) whether the battery 120 is fully charged. If not, this means that the battery charge level is above the predetermined threshold but less than being fully charged. In other words, the battery charge is close to the fully charged state. In such a scenario, the controller 108 adjusts (block 270) the power profile and battery charging configuration from the initial start (block 201) state. In particular, to adjust the power profile, the controller 108 transmits PD instructions to the PD controller 112, which in turn transmits the PD control data to the PD source 102. The PD instructions in this scenario cause the PD source 102 to adjust the power profile by reducing the VBUS voltage from the maximum current setting to a reduced VBUS voltage, which may be a VBUS voltage that is passed on to the battery charger 116 via the output of the DC-DC converter 114. The VBUS voltage may be selected in this scenario such that the Vin voltage provided to the battery charger 116 is close to the current voltage level of the battery 120, thereby increasing the efficiency of the battery charger 116.

To provide another non-limiting and illustrative scenario, when the host device 104 is in an idle state or other non-active use state and the battery state of charge is greater than 90%, the battery 120 may be charged in a constant voltage mode, and the load requirement on battery charge gradually reduces. In such case, the power profile is further renegotiated to lower levels, such as 20V/3 A, to achieve better efficiency. The controller 108 also transmits the battery charger control data to the battery charger 116, which causes the battery charger 116 to operate in a constant voltage charging mode to charge the battery 120.

That is, because the resistance of batteries increase as their charging level increases, it is more efficient to charge batteries using a constant current charging configuration up to a certain threshold charging level, and then switch to a constant voltage charging level. In this way, the threshold battery charge level may be selected to ensure that the battery charger 116 operates with an improved efficiency as the battery is charged over time.

The controller 108 may continue to monitor the state of charge of the battery 120 by periodically repeating the determination (block 268) of whether the state of charge of the battery 120 is fully charged. When the battery 120 is fully charged, then the flow 260 comprises operating (block 272) the battery charger 120 in the PTM of operation and disconnecting the battery 120 from the system bus. That is, the controller 108 transmits battery charger control data to the battery charger 116, which causes the battery charger 116 to operate in the PTM and to decouple the Vsys bus from the Vbat bus via the switching circuitry 118. The host device 104 thus uses the power provided by the PD source 102 as the system power versus drawing this power from the battery 120.

Moreover, to adjust the power profile, the controller 108 transmits PD instructions to the PD controller 112, which in turn transmits the PD control data to the PD source 102. The PD instructions in this scenario cause the PD source 102 to adjust the power profile by reducing the VBUS voltage from the maximum current setting to a reduced VBUS voltage, which may be a VBUS voltage that is passed on to the battery charger 116 via the output of the DC-DC converter 114. The VBUS voltage may be selected in this scenario such that the Vin voltage provided to the battery charger 116 is closer to the voltage level of the battery 120, thereby increasing the efficiency of the battery charger 116. To provide another non-limiting and illustrative scenario, when the host device 104 is in an idle state or other non-active use state and the battery state is fully charged, in such scenarios the battery charger 116 enables the PTM, which results in no active switching in the battery charger 116 and thus no switching losses. Also, reducing the VBUS voltage level facilitates a reduction in switching losses for other downstream voltage regulators (not shown).

The scenario discussed with respect to the flows showing in FIGS. 2A-2C assume that the starting power profile is a maximum power delivery for which the PD source 102 is capable of delivering to the host device 104. However, the power delivery architecture 100 may continue to adjust this power profile based upon other system conditions once the power profile has been adjusted. Thus, FIGS. 3A-3C, illustrate a flow diagram for managing power delivery (PD) power profiles and battery charging modes once a power delivery contract is established, in accordance with the disclosure.

FIG. 3A illustrates a flow 300 that begins (block 301) with the PD source 102 already having established a power profile contract with the host device 104, which may comprise any suitable power profile such as a maximum power profile, a previously-adjusted power profile (such as via any of the blocks from the flows of FIGS. 2A-2C), etc. The flow 300 comprises the controller 108 determining (block 302) a current power state of the host device. Thus, block 302 may be identical to block 208 as shown and discussed above with respect to FIG. 2A. However, the flows as shown in FIG. 3A-3C consider an additional power state in block 304, and also consider additional system conditions with respect to the non-active use state.

Thus, if the current power state is (block 304) a power-down state, i.e. an off state, then the flow 300 proceeds to the flow 320 as shown in FIG. 3B. However, in the event that the current power state is an active use state, then the flow 300 proceeds to flow 220 as shown and discussed above with respect to FIG. 2B. Moreover, if the current power state comprises a non-active use state, such as an idle or sleep state, then the flow 300 comprises determining (block 310) whether the current time of day is within a predetermined range of working hours. If so, then the flow 300 proceeds to the flow 260 as shown and discussed above with respect to FIG. 2C.

However, in the event that the current time of day is outside the predetermined range of working hours, then the flow 300 also proceeds to the flow 320 as shown in FIG. 3B, i.e. in the same manner as the powered-down state noted above for block 304. Thus, the controller 108 may be configured to transmit the PD instructions to the PD controller 112 based further upon other system conditions, such as whether a current time of day is within a predetermined range of working hours for the host device 104.

In other words, the flow 320 as shown in FIG. 3B corresponds to a scenario in which the host device 104 is in a powered-down state or, alternatively, in a non-active use state but outside of predetermined working hours that are known to the controller 108. Turning now to FIG. 3B, the flow 320 comprises the controller 108 determining (block 322) a state of charge of the battery 120, as discussed above for block 222 of flow 220. The controller 108 then determines (block 324) whether the battery charge level is greater than or equal to a predetermined threshold, which may include the battery being fully charged. Again, the predetermined threshold may be any suitable value that indicates that the battery 120 is mostly charged, such as 85%, 90%, 95%, etc., or that the battery is fully charged (i.e. 100%). If not, then the flow 320 comprises adjusting (block 326) the power profile to reduce the VBUS voltage and to adjust the battery charging operation to charge the battery 120 in a constant current mode of operation, which may be performed in the same manner as described above with respect to the blocks 226, 266 of the flows 220, 260, respectively. Again, although the block 326 is shown in the Figures as using constant current charging, this is a non-limiting and illustrative scenario. It is noted that the charging mode of operation associated with block 326 may comprise any suitable charging scheme, such as a constant voltage charging operation as discussed above with respect to block 270. Thus, at block 326 the controller 108 is configured to transmit the battery PD instructions to the PD controller 112 to cause the PD source 102 to reduce the VBUS voltage closer to the battery voltage to improve battery charging efficiency.

Thus, if the battery state of charge is greater than the predetermined threshold value, (or not fully charged), then the flow 300 comprises the controller 108 turning off (block 328) the PD source 102. In this way, the controller 108 is configured to transmit the battery PD instructions to the PD controller 112 further based upon a system condition that includes the state of charge of the battery 120. That is, the controller 108 is configured to transmit the PD instructions to the PD controller 112 further based upon the system condition of the battery 120 being either fully charged or mostly charged. In this scenario, the PD control data causes the PD source 102 to adjust the PD power profile by turning off AC-DC conversion such that the battery 120 continues to provide power to the host device 104. Therefore, it is noted that the term power profile as used herein may comprise an off state of the PD source 102 or, alternatively, any suitable combination of the VBUS voltage and current values as discussed herein.

The PD control data in this scenario may comprise a PD source specific message that instructs the PD source 102 to power off AC-DC conversion components. This message may comprise, in some non-limiting and illustrative scenarios, a vendor-defined message (VDM) that is recognized by the PD source 102 when received. Thus, the controller 108 may determine the format and content of the PD control data as a VDM, which is provided as part of the PD instructions provided to the controller 112. The PD source 102 may then subsequently cease to output a VBUS voltage and, in turn, the host device system draws (block 330) power from the battery 120 without charging the battery 120.

The host device 104 continues to draw power from the battery 120 in this scenario, and the controller 108 may periodically determine (block 332) the state of charge of the battery 120 and also determine (block 334) whether the current charge level is less than a predetermined threshold value. The host device 104 may continue to draw power from the battery 120 in this state until the battery charge level falls below the predetermined threshold value. At this time, the controller 108 causes the PD source 102 to turn back on the AC-DC functions, and the flow 320 returns to block 326 such that the battery charger 116 may continue to charge the battery 120.

In any event, the controller 108 is thus configured to transmit PD instructions to the PD controller 112 in this scenario based upon the further system condition of the battery charging level of the battery 120 dropping below a predetermined threshold battery level. The PD controller 112 is configured to transmit PD control data to the PD source 102 based upon these PD instructions. The PD control data may comprise a VDM, and may cause the PD source 102 to adjust the power profile by turning back on (from the previous power profile being off) such that the power profile is once again used to provide power to the host device 104 and the battery 120 is charged.

Thus, to provide another non-limiting and illustrative scenario, the host device 104 is assumed to be in a powered-down state (block 304) or in a non-active use state (block 308) and outside of working hours (block 310, No). Continuing this scenario, if the battery state of charge is not fully charged and is less than the predetermined threshold value (block 334, yes), then the battery 120 may be charged in a constant current mode via the battery charger 116 (block 326). The power profile may thus be renegotiated (block 326) by the controller 108 afer the PD source 102 is turned back on (block 336), which results in the VBUS voltage being reduced to a lower voltage level, improving the AC-DC adapter conversion efficiency. Continuing this scenario, if the battery state of charge is greater than 90%, the PD explicit contract can be exited, and the VBUS voltage from AC-DC adapter can be shut off. The platform can then continue to draw the required power from the battery in this power state.

Thus, the power delivery architecture 100 as discussed herein may improve the efficiency of the PD source 102 in addition to the efficiency of the DC-DC converter 114 and the battery charger 116. This is demonstrated in Tables 5 and 6 below. For instance, the workload scenarios as shown in Tables 5 and 6 correspond to different manufactured host devices 104, each implementing the power delivery architecture 100 as discussed herein. Tables 5 and 6 provide additional detail with respect to the AC to DC power conversion consumption and efficiency of the PD source 102 for different workload conditions.

Each workload condition corresponds to a non-active use state, with one being an idle state in which the display is turned off and the other a deep sleep state in which additional components of the system 106 are shutdown or placed into a standby mode to conserve power. The different AC-DC adapter output voltages correspond to the various VBUS voltages associated with respective power profiles. Table 5 thus represents the typical AC-DC power consumption and efficiencies for various power profiles and workloads. For Table 5, the efficiency column represents generic efficiency numbers considered from a typical flyback converter design. Table 6 provides the same information when 0.5 C charging is implemented via the battery charger 116.

TABLE 5

| | | | | | | AC to DC adapter | | |
|---|---|---|---|---|---|---|---|---|
| | | | | | | Conversion | | |
| | | | | | | Efficiency Reduction | | |
| | | | | | AC to DC | in Power Consumption | | |
| | | | AC to DC | | adapter | AC to DC | | |
| | | Platform | adapter | | output | adapter | | Reduction |
| | Workload/Test | Power | output | | power | input power | | in Power |
| Use | Condition | (mW) | V | | (mW) | (mW) | Efficiency | Consumption |
| 1 | Idle display off | 1481 | 5 | V | 1763 | 2382 | ~74% | 66% |
| | | | 9 | V | 1702 | 2503 | ~68% | |
| | | | 15 | V | 1763 | 2812 | ~62.7% | |
| | | | 20 | V | 1806 | 3114 | ~58% | |
| | | | 28 | V | 2962 | 4808 | ~61.6% | |
| | | | 48 | V | 4231 | 7052 | ~60% | |
| 2 | Deep sleep state | 167 | 5 | V | 239 | 797 | ~30% | 85.68% |
| | | | 9 | V | 239 | 1150 | ~20% | |
| | | | 15 | V | 232 | 1160 | ~20% | |
| | | | 20 | V | 334 | 3340 | ~10% | |
| | | | 28 | V | 417.5 | 4175 | ~10% | |
| | | | 48 | V | 556.7 | 5567 | ~10% | |

TABLE 6

| | | | | | AC to DC adapter | | |
|---|---|---|---|---|---|---|---|
| | | | | | Conversion | | |
| | | | | | Efficiency Reduction | | |
| | | | | AC to DC | in Power Consumption | | |
| | | | AC to DC | adapter | AC to DC | | |
| | | Platform | adapter | output | adapter | | Reduction |
| | Workload/Test | Power | output | power | input power | | in Power |
| Use | Condition | (mW) | V | (mW) | (mW) | Efficiency | Consumption |
| 1 | Idle display off | 52610 | 20 V | 54237 | 58953 | ~92% | Max 7.87% |
| | | | 28 V | 55379 | 60195 | ~92% | Min 3.07% |
| | | | 48 V | 57497 | 62025 | ~92.7% | |
| | | | PTM | 53141 | 57141 | ~93% | |
| 2 | Deep sleep state | 51296 | 20 V | 52883 | 57482 | ~92% | Max 8.38% |
| | | | 28 V | 53996 | 58691 | ~92% | Min 3.08% |
| | | | 48 V | 56369 | 60808 | ~92.7% | |
| | | | PTM | 51814 | 55714 | ~93% | |

As noted above for Tables 3 and 4, the workload scenarios as shown in Tables 5 and 6 above are also provided in an illustrative and non-limiting manner, and the power delivery architecture 100 as discussed herein may utilize additional, alternate, or fewer workload scenarios as shown as system conditions upon which the decision to adjust the power profile and/or the battery charging operation may be based.

The flows provided in FIGS. 2A-2C and 3A-3B illustrate various system conditions that may facilitate adjustments to the power profile provided by the PD source 102 and/or the battery charging mode implemented via the battery charger 116. However, these system conditions, as well as the order and prioritization of these system conditions, are provided as non-limiting and illustrative scenarios. Additional or alternate system conditions may be considered as part of the adjustment of the power profile and/or battery charging mode of operation, and such additional or alternate conditions may be combined with any of the system conditions as shown and discussed with respect to the flows of FIGS. 2A-2C and 3A-3B or be considered as separate and independent system conditions.

To provide an illustrative and non-limiting scenario, an additional or alternative system condition may comprise a temperature of one or more portions of the host device 104. The temperature may be identified with an internal or external component of the host device 104, such as an outer surface of the host device 104. The temperature may be measured via any suitable type of sensor, and be provided to the controller 108 as part of the status data as discussed herein. In such a scenario, the temperature data may be used as a system condition to adjust the power profile and/or battery charging mode of operation as discussed herein. Thus, the controller 108 may be configured to transmit the PD instructions to the PD controller 112 when the status data indicates that a temperature of a portion of the host device 104 exceeds a predetermined threshold temperature. In response, the PD controller 112 may transmit PD control data to the PD source 102 based upon the PD instructions, which causes the PD source 102 to adjust the power profile that is used to provide power to the host device 104.

In this way, better thermal control may be achieved via dynamically changing the power profile. To provide an illustrative and non-limiting scenario, during fast charging of the battery 120, a surface temperature of the host device 104 may reach near a maximum temperature that is allowed in the vicinity of the battery charger 116. In this case, fast charging may be disabled and the battery 120 subsequently charged with a lower current, which results in an overall reduction in input power required for the system. Hence, with a lower input power demand, a new power profile is renegotiated to reduce losses in the battery charger 116, which in turn reduces the surface temperature of the host device 104.

### IV. General Configuration of a System

A system is provided. The system comprises a data interface configured to receive status data via one or more components of an electronic device; and an embedded controller configured to determine a power state of the electronic device based upon the received status data, and to transmit power delivery (PD) instructions to a PD controller based upon the determined power state, the PD instructions are used by the PD controller to transmit PD control data to cause a PD source to adjust a PD power profile to provide power to the electronic device. In addition or in alternative to and in any combination with the optional features previously explained in this paragraph, the PD power profile comprises a combination of a VBUS voltage and a current that complies with a universal serial bus (USB) power delivery profile specification, and the PD control data is transmitted to the PD source in accordance with a USB communication protocol. In addition or in alternative to and in any combination with the optional features previously explained in this paragraph, the embedded controller is configured to transmit the PD instructions to the PD controller further based upon a battery of the electronic device being fully charged, and the PD control data causes the PD source to adjust the PD power profile by turning off such that the battery provides power to the electronic device. In addition or in alternative to and in any combination with the optional features previously explained in this paragraph, the embedded controller is configured to transmit further PD instructions to the PD controller when a battery charging level of the battery drops below a predetermined threshold battery level, the further PD instructions are used by the PD controller to transmit further PD control data to the PD source, and the further PD control data causes the PD source to adjust the PD power profile by turning back on such that the PD power profile is used to provide power to the electronic device. In addition or in alternative to and in any combination with the optional features previously explained in this paragraph, the power state comprises a powered-down state or a non-active use state. In addition or in alternative to and in any combination with the optional features previously explained in this paragraph,: the embedded controller is configured to transmit further PD instructions to the PD controller when the status data indicates that a temperature of a portion of the electronic device exceeds a predetermined threshold temperature, further PD instructions are used by the PD controller to transmit further PD control data to the PD source, and the further PD control data causes the PD source to further adjust the PD power profile that is used to provide power to the electronic device. In addition or in alternative to and in any combination with the optional features previously explained in this paragraph, the electronic device is configured to operate in accordance with one of a plurality of power policy settings that include a high performance setting in which the PD power profile comprises a maximum voltage that is supported by the PD source, and the embedded controller is configured to only determine the power state of the electronic device and to only transmit the PD instructions to the PD controller based upon the determined power state when the electronic device is operating in accordance with one of the plurality of power policy settings other than the high performance setting. In addition or in alternative to and in any combination with the optional features previously explained in this paragraph,: the power state comprises an active use state, the embedded controller is configured to identify a current workload of the electronic device when the status data indicates that a charged state of a battery of the electronic device is greater than a predetermined threshold value, and the PD control data causes the PD source to adjust the PD power profile that is used to provide power to the electronic device based upon the identified workload. In addition or in alternative to and in any combination with the optional features previously explained in this paragraph, the power state comprises a non-active use state, the embedded controller is configured to transmit battery charger control data to a battery charger, when a battery charging level of a battery of the electronic device is less than a predetermined threshold charging level, the battery charger control data causes the battery charger to operate in a constant current charging mode to charge the battery; when the battery charging level is greater than the predetermined threshold charging level but is less than fully charged, the battery charger control data causes the battery charger to operate in a constant voltage charging mode to charge the battery; and when the battery charging level is fully charged, the battery charger control data causes the battery charger to operate in a pass-thru mode and disconnect the battery. In addition or in alternative to and in any combination with the optional features previously explained in this paragraph, the power state comprises a non-active use state during a time of day, the embedded controller is configured to transmit the PD instructions to the PD controller further based upon whether a current time of day is within a predetermined range of working hours for the electronic device.

### V. General Configuration of a Non-Transitory Computer-Readable Medium

A non-transitory computer-readable medium is provided. The non-transitory computer-readable medium has instructions stored thereon that, when executed by processing circuitry of an electronic device, cause the electronic device to: receive status data via one or more components of an electronic device; determine a power state of the electronic device based upon the received status data; transmit power delivery (PD) instructions to a PD controller based upon the determined power state, the PD instructions are used by the PD controller to transmit PD control data to cause a PD source to adjust a PD power profile that is used to provide power to the electronic device. In addition or in alternative to and in any combination with the optional features previously explained in this paragraph, the PD power profile comprises a combination of a VBUS voltage and a current that complies with a universal serial bus (USB) power delivery profile specification, and the PD control data is transmitted to the PD source in accordance with a USB communication protocol. In addition or in alternative to and in any combination with the optional features previously explained in this paragraph, the instructions, when executed by the processing circuitry of the electronic device, further cause the electronic device to transmit the PD instructions to the PD controller further based upon a battery of the electronic device being fully charged, and the PD control data causes the PD source to adjust the PD power profile by turning off such that the battery provides power to the electronic device. In addition or in alternative to and in any combination with the optional features previously explained in this paragraph, the instructions, when executed by the processing circuitry of the electronic device, further cause the electronic device to transmit further PD instructions to the PD controller when a battery charging level of the battery drops below a predetermined threshold battery level, the further PD instructions are used by the PD controller to transmit further PD control data to the PD source, and the further PD control data causes the PD source to adjust the PD power profile by turning back on such that the PD power profile is used to provide power to the electronic device. In addition or in alternative to and in any combination with the optional features previously explained in this paragraph, the power state comprises a powered-down state or a non-active use state. In addition or in alternative to and in any combination with the optional features previously explained in this paragraph, the instructions, when executed by the processing circuitry of the electronic device, further cause the electronic device to transmit further PD instructions to the PD controller when the status data indicates that a temperature of a portion of the electronic device exceeds a predetermined threshold temperature, the further PD instructions are used by the PD controller to transmit further PD control data to the PD source, and the further PD control data causes the PD source to further adjust the PD power profile that is used to provide power to the electronic device. In addition or in alternative to and in any combination with the optional features previously explained in this paragraph, the electronic device is configured to operate in accordance with one of a plurality of power policy settings that include a high performance setting in which the PD power profile comprises a maximum voltage that is supported by the PD source, and the instructions, when executed by the processing circuitry of the electronic device, further cause the electronic device to only determine the power state of the electronic device and to only transmit the PD instructions to the PD controller based upon the determined power state when the electronic device is operating in accordance with one of the plurality of power policy settings other than the high performance setting. In addition or in alternative to and in any combination with the optional features previously explained in this paragraph, the power state comprises an active use state, the instructions, when executed by the processing circuitry of the electronic device, further cause the electronic device to identify a current workload of the electronic device when the status data indicates that a charged state of a battery of the electronic device is greater than a predetermined threshold value, and the PD control data causes the PD source to adjust the PD power profile that is used to provide power to the electronic device based upon the identified workload. In addition or in alternative to and in any combination with the optional features previously explained in this paragraph, the power state comprises a non-active use state, the instructions, when executed by the processing circuitry of the electronic device, further cause the electronic device to transmit battery charger control data to a battery charger, when a battery charging level of a battery of the electronic device is less than a predetermined threshold charging level, the battery charger control data causes the battery charger to operate in a constant current charging mode to charge the battery, when the battery charging level is greater than the predetermined threshold charging level but is less than fully charged, the battery charger control data causes the battery charger to operate in a constant voltage charging mode to charge the battery, and when the battery charging level is fully charged, the battery charger control data causes the battery charger to operate in a pass-thru mode and disconnect the battery. In addition or in alternative to and in any combination with the optional features previously explained in this paragraph, the power state comprises a non-active use state during a time of day, the instructions, when executed by the processing circuitry of the electronic device, further cause the electronic device to transmit the PD instructions to the PD controller further based upon whether a current time of day is within a predetermined range of working hours for the electronic device.

### EXAMPLES

The following examples pertain to various techniques of the present disclosure.

An example (e.g. example 1) is directed to a system, comprising: a data interface configured to receive status data via one or more components of an electronic device; and an embedded controller configured to determine a power state of the electronic device based upon the received status data, and to transmit power delivery (PD) instructions to a PD controller based upon the determined power state, wherein the PD instructions are used by the PD controller to transmit PD control data to cause a PD source to adjust a PD power profile to provide power to the electronic device.

Another example (e.g. example 2) relates to a previously-described example (e.g. example 1), wherein the PD power profile comprises a combination of a VBUS voltage and a current that complies with a universal serial bus (USB) power delivery profile specification, and wherein the PD control data is transmitted to the PD source in accordance with a USB communication protocol.

Another example (e.g. example 3) relates to a previously-described example (e.g. one or more of examples 1-2), wherein: the embedded controller is configured to transmit the PD instructions to the PD controller further based upon a battery of the electronic device being fully charged, and the PD control data causes the PD source to adjust the PD power profile by turning off such that the battery provides power to the electronic device.

Another example (e.g. example 4) relates to a previously-described example (e.g. one or more of examples 1-3), wherein: the embedded controller is configured to transmit further PD instructions to the PD controller when a battery charging level of the battery drops below a predetermined threshold battery level, the further PD instructions are used by the PD controller to transmit further PD control data to the PD source, and the further PD control data causes the PD source to adjust the PD power profile by turning back on such that the PD power profile is used to provide power to the electronic device.

Another example (e.g. example 5) relates to a previously-described example (e.g. one or more of examples 1-4), wherein the power state comprises a powered-down state or a non-active use state.

Another example (e.g. example 6) relates to a previously-described example (e.g. one or more of examples 1-5), wherein: the embedded controller is configured to transmit further PD instructions to the PD controller when the status data indicates that a temperature of a portion of the electronic device exceeds a predetermined threshold temperature, further PD instructions are used by the PD controller to transmit further PD control data to the PD source, and the further PD control data causes the PD source to further adjust the PD power profile that is used to provide power to the electronic device.

Another example (e.g. example 7) relates to a previously-described example (e.g. one or more of examples 1-6), wherein the electronic device is configured to operate in accordance with one of a plurality of power policy settings that include a high performance setting in which the PD power profile comprises a maximum voltage that is supported by the PD source, and wherein the embedded controller is configured to only determine the power state of the electronic device and to only transmit the PD instructions to the PD controller based upon the determined power state when the electronic device is operating in accordance with one of the plurality of power policy settings other than the high performance setting.

Another example (e.g. example 8) relates to a previously-described example (e.g. one or more of examples 1-7), wherein: the power state comprises an active use state, the embedded controller is configured to identify a current workload of the electronic device when the status data indicates that a charged state of a battery of the electronic device is greater than a predetermined threshold value, and the PD control data causes the PD source to adjust the PD power profile that is used to provide power to the electronic device based upon the identified workload.

Another example (e.g. example 9) relates to a previously-described example (e.g. one or more of examples 1-8), wherein: the power state comprises a non-active use state, the embedded controller is configured to transmit battery charger control data to a battery charger, when a battery charging level of a battery of the electronic device is less than a predetermined threshold charging level, the battery charger control data causes the battery charger to operate in a constant current charging mode to charge the battery; when the battery charging level is greater than the predetermined threshold charging level but is less than fully charged, the battery charger control data causes the battery charger to operate in a constant voltage charging mode to charge the battery; and when the battery charging level is fully charged, the battery charger control data causes the battery charger to operate in a pass-thru mode and disconnect the battery.

Another example (e.g. example 10) relates to a previously-described example (e.g. one or more of examples 1-9), wherein: the power state comprises a non-active use state during a time of day, the embedded controller is configured to transmit the PD instructions to the PD controller further based upon whether a current time of day is within a predetermined range of working hours for the electronic device.

An example (e.g. example 11) is directed to a non-transitory computer-readable medium having instructions stored thereon that, when executed by processing circuitry of an electronic device, cause the electronic device to: receive status data via one or more components of an electronic device; determine a power state of the electronic device based upon the received status data; transmit power delivery (PD) instructions to a PD controller based upon the determined power state, wherein the PD instructions are used by the PD controller to transmit PD control data to cause a PD source to adjust a PD power profile that is used to provide power to the electronic device.

Another example (e.g. example 12) relates to a previously-described example (e.g. example 11), wherein the PD power profile comprises a combination of a VBUS voltage and a current that complies with a universal serial bus (USB) power delivery profile specification, and wherein the PD control data is transmitted to the PD source in accordance with a USB communication protocol.

Another example (e.g. example 13) relates to a previously-described example (e.g. one or more of examples 11-12), wherein the instructions, when executed by the processing circuitry of the electronic device, further cause the electronic device to transmit the PD instructions to the PD controller further based upon a battery of the electronic device being fully charged, and wherein the PD control data causes the PD source to adjust the PD power profile by turning off such that the battery provides power to the electronic device.

Another example (e.g. example 14) relates to a previously-described example (e.g. one or more of examples 11-13), wherein: the instructions, when executed by the processing circuitry of the electronic device, further cause the electronic device to transmit further PD instructions to the PD controller when a battery charging level of the battery drops below a predetermined threshold battery level, the further PD instructions are used by the PD controller to transmit further PD control data to the PD source, and the further PD control data causes the PD source to adjust the PD power profile by turning back on such that the PD power profile is used to provide power to the electronic device.

Another example (e.g. example 15) relates to a previously-described example (e.g. one or more of examples 11-14), wherein the power state comprises a powered-down state or a non-active use state.

Another example (e.g. example 16) relates to a previously-described example (e.g. one or more of examples 11-15), wherein: the instructions, when executed by the processing circuitry of the electronic device, further cause the electronic device to transmit further PD instructions to the PD controller when the status data indicates that a temperature of a portion of the electronic device exceeds a predetermined threshold temperature, the further PD instructions are used by the PD controller to transmit further PD control data to the PD source, and the further PD control data causes the PD source to further adjust the PD power profile that is used to provide power to the electronic device.

Another example (e.g. example 17) relates to a previously-described example (e.g. one or more of examples 11-16), wherein the electronic device is configured to operate in accordance with one of a plurality of power policy settings that include a high performance setting in which the PD power profile comprises a maximum voltage that is supported by the PD source, and wherein the instructions, when executed by the processing circuitry of the electronic device, further cause the electronic device to only determine the power state of the electronic device and to only transmit the PD instructions to the PD controller based upon the determined power state when the electronic device is operating in accordance with one of the plurality of power policy settings other than the high performance setting.

Another example (e.g. example 18) relates to a previously-described example (e.g. one or more of examples 11-17), wherein: the power state comprises an active use state, the instructions, when executed by the processing circuitry of the electronic device, further cause the electronic device to identify a current workload of the electronic device when the status data indicates that a charged state of a battery of the electronic device is greater than a predetermined threshold value, and the PD control data causes the PD source to adjust the PD power profile that is used to provide power to the electronic device based upon the identified workload.

Another example (e.g. example 19) relates to a previously-described example (e.g. one or more of examples 11-18), wherein: the power state comprises a non-active use state, the instructions, when executed by the processing circuitry of the electronic device, further cause the electronic device to transmit battery charger control data to a battery charger, when a battery charging level of a battery of the electronic device is less than a predetermined threshold charging level, the battery charger control data causes the battery charger to operate in a constant current charging mode to charge the battery, when the battery charging level is greater than the predetermined threshold charging level but is less than fully charged, the battery charger control data causes the battery charger to operate in a constant voltage charging mode to charge the battery, and when the battery charging level is fully charged, the battery charger control data causes the battery charger to operate in a pass-thru mode and disconnect the battery.

Another example (e.g. example 20) relates to a previously-described example (e.g. one or more of examples 11-19), wherein: the power state comprises a non-active use state during a time of day, the instructions, when executed by the processing circuitry of the electronic device, further cause the electronic device to transmit the PD instructions to the PD controller further based upon whether a current time of day is within a predetermined range of working hours for the electronic device.

An example (e.g. example 21) is directed to a system, comprising: a data interface means for receiving status data via one or more components of an electronic device; and an embedded controller means for determining a power state of the electronic device based upon the received status data, and to transmit power delivery (PD) instructions to a PD controller based upon the determined power state, wherein the PD instructions are used by the PD controller to transmit PD control data to cause a PD source means to adjust a PD power profile to provide power to the electronic device.

Another example (e.g. example 22) relates to a previously-described example (e.g. example 21), wherein the PD power profile comprises a combination of a VBUS voltage and a current that complies with a universal serial bus (USB) power delivery profile specification, and wherein the PD control data is transmitted to the PD source means in accordance with a USB communication protocol.

Another example (e.g. example 23) relates to a previously-described example (e.g. one or more of examples 21-22), wherein: the embedded controller means transmits the PD instructions to the PD controller further based upon a battery of the electronic device being fully charged, and the PD control data causes the PD source means to adjust the PD power profile by turning off such that the battery provides power to the electronic device.

Another example (e.g. example 24) relates to a previously-described example (e.g. one or more of examples 21-23), wherein: the embedded controller means transmits further PD instructions to the PD controller when a battery charging level of the battery drops below a predetermined threshold battery level, the further PD instructions are used by the PD controller to transmit further PD control data to the PD source means, and the further PD control data causes the PD source means to adjust the PD power profile by turning back on such that the PD power profile is used to provide power to the electronic device.

Another example (e.g. example 25) relates to a previously-described example (e.g. one or more of examples 21-24), wherein the power state comprises a powered-down state or a non-active use state.

Another example (e.g. example 26) relates to a previously-described example (e.g. one or more of examples 21-25), wherein: the embedded controller means transmits further PD instructions to the PD controller when the status data indicates that a temperature of a portion of the electronic device exceeds a predetermined threshold temperature, the further PD instructions are used by the PD controller to transmit further PD control data to the PD source means, and the further PD control data causes the PD source means to further adjust the PD power profile that is used to provide power to the electronic device.

Another example (e.g. example 27) relates to a previously-described example (e.g. one or more of examples 21-26), wherein the electronic device is configured to operate in accordance with one of a plurality of power policy settings that include a high performance setting in which the PD power profile comprises a maximum voltage that is supported by the PD source means, and wherein the embedded controller means only determines the power state of the electronic device and to only transmit the PD instructions to the PD controller based upon the determined power state when the electronic device is operating in accordance with one of the plurality of power policy settings other than the high performance setting.

Another example (e.g. example 28) relates to a previously-described example (e.g. one or more of examples 21-27), wherein: the power state comprises an active use state, the embedded controller means identifies a current workload of the electronic device when the status data indicates that a charged state of a battery of the electronic device is greater than a predetermined threshold value, and the PD control data causes the PD source means to adjust the PD power profile that is used to provide power to the electronic device based upon the identified workload.

Another example (e.g. example 29) relates to a previously-described example (e.g. one or more of examples 21-28), wherein: the power state comprises a non-active use state, the embedded controller is configured to transmit battery charger control data to a battery charging means, when a battery charging level of a battery of the electronic device is less than a predetermined threshold charging level, the battery charger control data causes the battery charging means to operate in a constant current charging mode to charge the battery; when the battery charging level is greater than the predetermined threshold charging level but is less than fully charged, the battery charger control data causes the battery charging means to operate in a constant voltage charging mode to charge the battery; and when the battery charging level is fully charged, the battery charger control data causes the battery charging means to operate in a pass-thru mode and disconnect the battery.

Another example (e.g. example 30) relates to a previously-described example (e.g. one or more of examples 21-29), wherein: the power state comprises a non-active use state during a time of day, the embedded controller means transmits the PD instructions to the PD controller further based upon whether a current time of day is within a predetermined range of working hours for the electronic device.

An example (e.g. example 31) is directed to a non-transitory computer-readable medium having instructions stored thereon that, when executed by a processing means of an electronic device, cause the electronic device to: receive status data via one or more components of an electronic device; determine a power state of the electronic device based upon the received status data; transmit power delivery (PD) instructions to a PD controller based upon the determined power state, wherein the PD instructions are used by the PD controller to transmit PD control data to cause a PD source means to adjust a PD power profile that is used to provide power to the electronic device.

Another example (e.g. example 32) relates to a previously-described example (e.g. example 31), wherein the PD power profile comprises a combination of a VBUS voltage and a current that complies with a universal serial bus (USB) power delivery profile specification, and wherein the PD control data is transmitted to the PD source means in accordance with a USB communication protocol.

Another example (e.g. example 33) relates to a previously-described example (e.g. one or more of examples 31-32), wherein the instructions, when executed by the processing means of the electronic device, further cause the electronic device to transmit the PD instructions to the PD controller further based upon a battery of the electronic device being fully charged, and wherein the PD control data causes the PD source means to adjust the PD power profile by turning off such that the battery provides power to the electronic device.

Another example (e.g. example 34) relates to a previously-described example (e.g. one or more of examples 31-33), wherein: the instructions, when executed by the processing means of the electronic device, further cause the electronic device to transmit further PD instructions to the PD controller when a battery charging level of the battery drops below a predetermined threshold battery level, the further PD instructions are used by the PD controller to transmit further PD control data to the PD source means, and the further PD control data causes the PD source means to adjust the PD power profile by turning back on such that the PD power profile is used to provide power to the electronic device.

Another example (e.g. example 35) relates to a previously-described example (e.g. one or more of examples 31-34), wherein the power state comprises a powered-down state or a non-active use state.

Another example (e.g. example 36) relates to a previously-described example (e.g. one or more of examples 31-35), wherein: the instructions, when executed by the processing means of the electronic device, further cause the electronic device to transmit further PD instructions to the PD controller when the status data indicates that a temperature of a portion of the electronic device exceeds a predetermined threshold temperature, the further PD instructions are used by the PD controller to transmit further PD control data to the PD source means, and the further PD control data causes the PD source means to further adjust the PD power profile that is used to provide power to the electronic device.

Another example (e.g. example 37) relates to a previously-described example (e.g. one or more of examples 31-36), wherein the electronic device is configured to operate in accordance with one of a plurality of power policy settings that include a high performance setting in which the PD power profile comprises a maximum voltage that is supported by the PD source means, and wherein the instructions, when executed by the processing means of the electronic device, further cause the electronic device to only determine the power state of the electronic device and to only transmit the PD instructions to the PD controller based upon the determined power state when the electronic device is operating in accordance with one of the plurality of power policy settings other than the high performance setting.

Another example (e.g. example 38) relates to a previously-described example (e.g. one or more of examples 31-37), wherein: the power state comprises an active use state, the instructions, when executed by the processing means of the electronic device, further cause the electronic device to identify a current workload of the electronic device when the status data indicates that a charged state of a battery of the electronic device is greater than a predetermined threshold value, and the PD control data causes the PD source means to adjust the PD power profile that is used to provide power to the electronic device based upon the identified workload.

Another example (e.g. example 39) relates to a previously-described example (e.g. one or more of examples 31-38), wherein: the power state comprises a non-active use state, the instructions, when executed by the processing means of the electronic device, further cause the electronic device to transmit battery charger control data to a battery charging means, when a battery charging level of a battery of the electronic device is less than a predetermined threshold charging level, the battery charger control data causes the battery charging means to operate in a constant current charging mode to charge the battery, when the battery charging level is greater than the predetermined threshold charging level but is less than fully charged, the battery charger control data causes the battery charging means to operate in a constant voltage charging mode to charge the battery, and when the battery charging level is fully charged, the battery charger control data causes the battery charging means to operate in a pass-thru mode and disconnect the battery.

Another example (e.g. example 40) relates to a previously-described example (e.g. one or more of examples 31-39), wherein: the power state comprises a non-active use state during a time of day, the instructions, when executed by the processing means of the electronic device, further cause the electronic device to transmit the PD instructions to the PD controller further based upon whether a current time of day is within a predetermined range of working hours for the electronic device.

An apparatus as shown and described

A method as shown and described.

### Conclusion

The aforementioned description will so fully reveal the general nature of the implementation of the disclosure that others can, by applying knowledge within the skill of the art, readily modify and/or adapt for various applications such specific implementations without undue experimentation and without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Each implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The exemplary implementations described herein are provided for illustrative purposes, and are not limiting. Other implementations are possible, and modifications may be made to the exemplary implementations. Therefore, the specification is not meant to limit the disclosure. Rather, the scope of the disclosure is defined only in accordance with the following claims and their equivalents.

Throughout the drawings, it should be noted that like reference numbers are used to depict the same or similar elements, features, and structures, unless otherwise noted. The terms “at least one” and “one or more” may be understood to include a numerical quantity

greater than or equal to one (e.g., one, two, three, four, [. . . ], etc.). The term “a plurality” may be understood to include a numerical quantity greater than or equal to two (e.g., two, three, four, five, [. . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. The phrase “at least one of” with regard to a group of elements may be used herein to mean a selection of: one of the listed elements, a plurality of one of the listed elements, a plurality of individual listed elements, or a plurality of a multiple of individual listed elements.

What is claimed is:

1. A system, comprising:
a data interface configured to receive status data via one or more components of an electronic device; and
an embedded controller configured to determine a power state of the electronic device based upon the received status data, and to transmit power delivery (PD) instructions to a PD controller based upon the determined power state,
wherein the PD instructions are used by the PD controller to transmit PD control data to cause a PD source to adjust a PD power profile to provide power to the electronic device.

2. The system of claim 1, wherein the PD power profile comprises a combination of a VBUS voltage and a current that complies with a universal serial bus (USB) power delivery profile specification, and
wherein the PD control data is transmitted to the PD source in accordance with a USB communication protocol.

3. The system of claim 1, wherein:
the embedded controller is configured to transmit the PD instructions to the PD controller further based upon a battery of the electronic device being fully charged, and
the PD control data causes the PD source to adjust the PD power profile by turning off such that the battery provides power to the electronic device.

4. The system of claim 3, wherein:
the embedded controller is configured to transmit further PD instructions to the PD controller when a battery charging level of the battery drops below a predetermined threshold battery level,
the further PD instructions are used by the PD controller to transmit further PD control data to the PD source, and
the further PD control data causes the PD source to adjust the PD power profile by turning back on such that the PD power profile is used to provide power to the electronic device.

5. The system of claim 4, wherein the power state comprises a powered-down state or a non-active use state.

6. The system of claim 1, wherein:
the embedded controller is configured to transmit further PD instructions to the PD controller when the status data indicates that a temperature of a portion of the electronic device exceeds a predetermined threshold temperature,
further PD instructions are used by the PD controller to transmit further PD control data to the PD source, and
the further PD control data causes the PD source to further adjust the PD power profile that is used to provide power to the electronic device.

7. The system of claim 1,
wherein the electronic device is configured to operate in accordance with one of a plurality of power policy settings that include a high performance setting in which the PD power profile comprises a maximum voltage that is supported by the PD source, and
wherein the embedded controller is configured to only determine the power state of the electronic device and to only transmit the PD instructions to the PD controller based upon the determined power state when the electronic device is operating in accordance with one of the plurality of power policy settings other than the high performance setting.

8. The system of claim 1, wherein:
the power state comprises an active use state,
the embedded controller is configured to identify a current workload of the electronic device when the status data indicates that a charged state of a battery of the electronic device is greater than a predetermined threshold value, and
the PD control data causes the PD source to adjust the PD power profile that is used to provide power to the electronic device based upon the identified workload.

9. The system of claim 1, wherein:
the power state comprises a non-active use state,
the embedded controller is configured to transmit battery charger control data to a battery charger,
when a battery charging level of a battery of the electronic device is less than a predetermined threshold charging level, the battery charger control data causes the battery charger to operate in a constant current charging mode to charge the battery;
when the battery charging level is greater than the predetermined threshold charging level but is less than fully charged, the battery charger control data causes the battery charger to operate in a constant voltage charging mode to charge the battery; and
when the battery charging level is fully charged, the battery charger control data causes the battery charger to operate in a pass-thru mode and disconnect the battery.

10. The system of claim 1, wherein:
the power state comprises a non-active use state during a time of day,
the embedded controller is configured to transmit the PD instructions to the PD controller further based upon whether a current time of day is within a predetermined range of working hours for the electronic device.

11. A non-transitory computer-readable medium having instructions stored thereon that, when executed by processing circuitry of an electronic device, cause the electronic device to:
receive status data via one or more components of an electronic device;
determine a power state of the electronic device based upon the received status data;
transmit power delivery (PD) instructions to a PD controller based upon the determined power state,
wherein the PD instructions are used by the PD controller to transmit PD control data to cause a PD source to adjust a PD power profile that is used to provide power to the electronic device.

12. The non-transitory computer-readable medium of claim 11, wherein the PD power profile comprises a combination of a VBUS voltage and a current that complies with a universal serial bus (USB) power delivery profile specification, and
wherein the PD control data is transmitted to the PD source in accordance with a USB communication protocol.

13. The non-transitory computer-readable medium of claim 11, wherein the instructions, when executed by the processing circuitry of the electronic device, further cause the electronic device to transmit the PD instructions to the PD controller further based upon a battery of the electronic device being fully charged, and
wherein the PD control data causes the PD source to adjust the PD power profile by turning off such that the battery provides power to the electronic device.

14. The non-transitory computer-readable medium of claim 13, wherein:
the instructions, when executed by the processing circuitry of the electronic device, further cause the electronic device to transmit further PD instructions to the PD controller when a battery charging level of the battery drops below a predetermined threshold battery level,
the further PD instructions are used by the PD controller to transmit further PD control data to the PD source, and
the further PD control data causes the PD source to adjust the PD power profile by turning back on such that the PD power profile is used to provide power to the electronic device.

15. The non-transitory computer-readable medium of claim 14, wherein the power state comprises a powered-down state or a non-active use state.

16. The non-transitory computer-readable medium of claim 11, wherein:
the instructions, when executed by the processing circuitry of the electronic device, further cause the electronic device to transmit further PD instructions to the PD controller when the status data indicates that a temperature of a portion of the electronic device exceeds a predetermined threshold temperature,
the further PD instructions are used by the PD controller to transmit further PD control data to the PD source, and
the further PD control data causes the PD source to further adjust the PD power profile that is used to provide power to the electronic device.

17. The non-transitory computer-readable medium of claim 11, wherein the electronic device is configured to operate in accordance with one of a plurality of power policy settings that include a high performance setting in which the PD power profile comprises a maximum voltage that is supported by the PD source, and
wherein the instructions, when executed by the processing circuitry of the electronic device, further cause the electronic device to only determine the power state of the electronic device and to only transmit the PD instructions to the PD controller based upon the determined power state when the electronic device is operating in accordance with one of the plurality of power policy settings other than the high performance setting.

18. The non-transitory computer-readable medium of claim 11, wherein:
the power state comprises an active use state,
the instructions, when executed by the processing circuitry of the electronic device, further cause the electronic device to identify a current workload of the electronic device when the status data indicates that a charged state of a battery of the electronic device is greater than a predetermined threshold value, and
the PD control data causes the PD source to adjust the PD power profile that is used to provide power to the electronic device based upon the identified workload.

19. The non-transitory computer-readable medium of claim 11, wherein:
the power state comprises a non-active use state,
the instructions, when executed by the processing circuitry of the electronic device, further cause the electronic device to transmit battery charger control data to a battery charger,
when a battery charging level of a battery of the electronic device is less than a predetermined threshold charging level, the battery charger control data causes the battery charger to operate in a constant current charging mode to charge the battery,
when the battery charging level is greater than the predetermined threshold charging level but is less than fully charged, the battery charger control data causes the battery charger to operate in a constant voltage charging mode to charge the battery, and
when the battery charging level is fully charged, the battery charger control data causes the battery charger to operate in a pass-thru mode and disconnect the battery.

20. The non-transitory computer-readable medium of claim 11, wherein:
the power state comprises a non-active use state during a time of day,
the instructions, when executed by the processing circuitry of the electronic device, further cause the electronic device to transmit the PD instructions to the PD controller further based upon whether a current time of day is within a predetermined range of working hours for the electronic device.
